(19) United States
(12) Patent Application Publication
(10) Pub. No.: US 2025/0291808 A1
(43) Pub. Date: Sep. 18, 2025

(54) ATTRIBUTE EXTRACTION AND ERROR DETECTION USING MULTI-MODAL DATA SOURCES AND MACHINE-LEARNING MODELS

(71) Applicant: Maplebear Inc., San Francisco, CA (US)

(72) Inventors: Saurav Manchanda, Seattle, WA (US); Prithvishankar Srinivasan, Seattle, WA (US); Shih-Ting Lin, Santa Clara, CA (US); Shishir Kumar Prasad, San Ramon, CA (US); Matthew William Darcy, Ottawa (CA); Paul Harrison Baranowski, Waxhaw, NC (US); Sonali Parthasarathy, Fremont, CA (US); Joon Suh Kwun, New York, NY (US); Peggy Men, Toronto (CA); Talha Aqeel Maswala, Oakville (CA)

(21) Appl. No.: 19/067,743

(22) Filed: Feb. 28, 2025

Related U.S. Application Data
(60) Provisional application No. 63/564,450, filed on Mar. 12, 2024.

(51) Int. Cl. G06F 16/25; G06F 16/28

(52) U.S. Cl. CPC G06F 16/252; G06F 16/285

(57) ABSTRACT

An online system enhances the accuracy and completeness of item attribute data in a catalog database by extracting attribute values from multiple data sources with different data modalities. The system applies machine-learning models to information sources such as text descriptions, images, third-party databases, and user engagement data. Extracted attributes are verified before being stored in the catalog. Contradictory attribute values are identified through cross-checking and flagged for audit. The system ranks data sources to prioritize high-confidence attribute extractions. A client interface enables users to specify desired attributes and extraction criteria, which guide multi-modal machine-learning models in retrieving relevant attributes. The system supports iterative refinement of attribute extraction processes based on user feedback and evaluation results. Additionally, extracted attributes can be used to filter catalog items, enhancing search and selection functionality.

### CROSS REFERENCE TO RELATED APPLICATIONS

This application claims the benefit of U.S. Provisional Application No. 63/564,450 filed Mar. 12, 2024, which is incorporated by reference herein in its entirety.

### BACKGROUND

An online system addresses attribute extraction and errors for large volumes of item data, which includes product names, descriptions, images, and other attributes. The problem of attribute error detection is particularly challenging due to the multi-modal nature of item data. For instance, a product's attributes can be available in both text and visual formats such as images. Traditional attribute extraction methods, which are primarily text-based, often fail to accurately extract attributes that are present in visual formats. This can lead to errors while extracting attributes from multi-modal item data, thereby compromising the overall data quality. Current methods to address attribute error detection primarily rely on manual verification, which is time-consuming, labor-intensive, and prone to human errors.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates a process of attribute extraction and cross-checking performed by the item attribute module, in accordance with one or more embodiments.

FIG. 4 illustrates an example system architecture for an attribute extraction platform, in accordance with one or more embodiments.

FIG. 5 illustrates a process of attribute extraction performed by the attribute extraction platform, in accordance with one or more embodiments.

FIG. 6 illustrates a process of the development and production phases of the attribute extraction platform, in accordance with one or more embodiments.

FIG. 7 is a flowchart for an item attribute module, in accordance with one or more embodiments.

### DETAILED DESCRIPTION

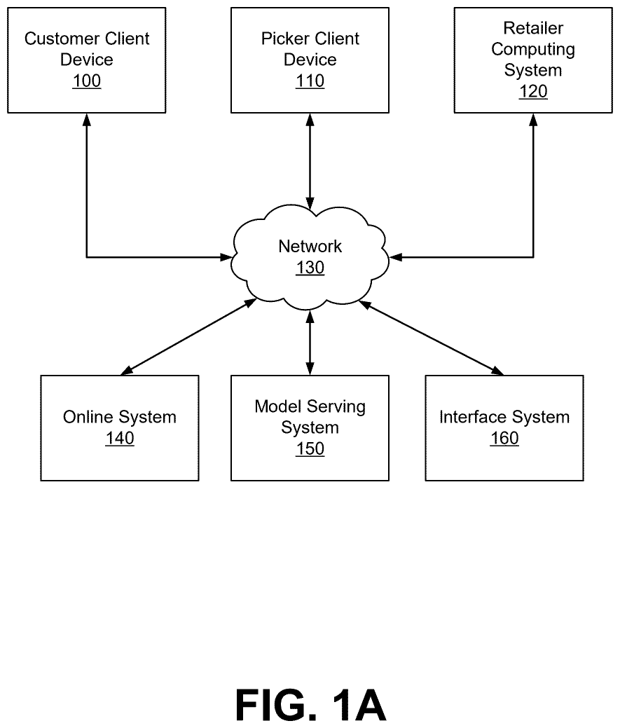

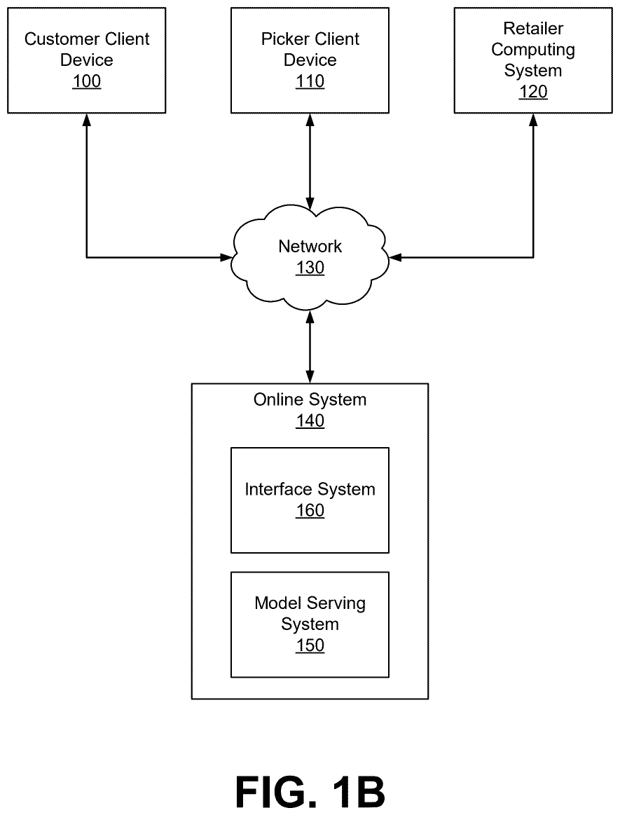

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item,” as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provide portions of the payment from the customer to the picker and the retailer.

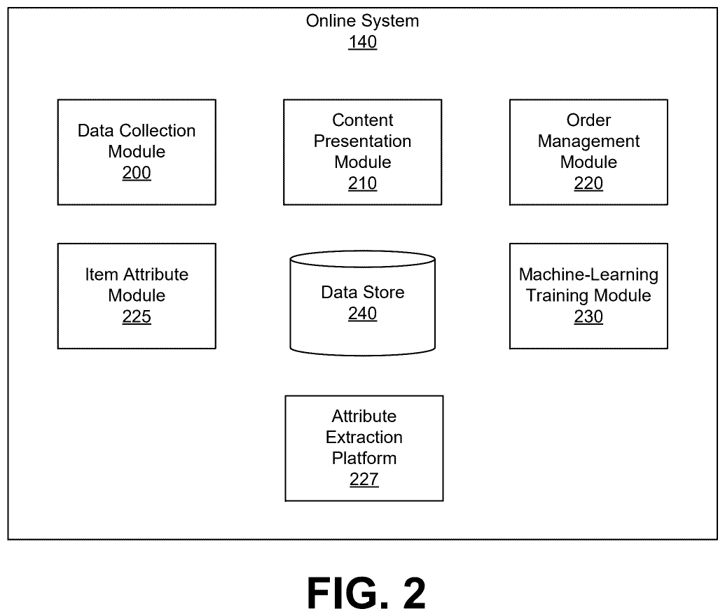

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

An online system 140 extracts, normalizes, and manages data attributes from multiple data sources. The online system 140 aggregates data from a variety of input sources and cross-references the extracted attributes from multi-modal data sources to determine consistent and reliable attributes for a given item. The online system 140 determines the extracted attributes from the varying data sources and confirms the determined attributes by cross-checking the determined attributes from the plurality of data source types. In one or more embodiments, the online system 140 includes a multi-modal machine learning model that is designed to extract attributes over multiple data sources through a unified extraction model. The online system 140 incorporates a multi-modal data processing workflow designed to perform attribute extraction for a plurality of items. For each item of the plurality of items, the online system 140 extracts attributes from a plurality of data source types. The online system 140 receives as input a desired attribute type, multiple data sources including information on the item, data associated with the plurality of items, and a prompt configured to extract the desired attribute from the received data. The online system 140 further performs normalization of the extracted attribute values to ensure compatibility and uniformity across different data formats. The online system 140 applies a quality screening mechanism to validate the extracted attributes to ensure the reliability of the determined attributes.

In one or more embodiments, the online system 140 further generates a user interface configured allow users of the online system 140 to create, customize and store configurations of the inputs for extracting the desired attributes. The user interface may allow for a user to specify the attribute types and configurations of the input to the multi-modal model to optimize for the attribute's extraction data.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 200 may collect appeasement requests per items from the historical data. An appeasement request may be due to one or more reasons but may comprise of an item that may be incorrect, incorrectly delivered, or missing. Further, data collection module 200 may construct a rate of appeasement per customer based on past customer order data. In other words, customers may have an identifier of a rate of appeasement determined by the number of appeasement requests from the customer's past order data.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

1. Error Detection for Item Attributes Extracted from Multi-Modal Data Sources

The item attribution module 225 determines if the attributes of an item are erroneous by cross-checking extracted attributes from multi-modal data sources. The item attribute module 225 extracts the item's attributes from several data sources. The item attribute module 225 determines the extracted attributes from the varying data sources and confirms the determined attributes by cross-checking the determined attributes from the varying data sources.

Item data includes data from multiple modalities, such as both text data and visual data which provide visual and non-visual attributes to describe items. Attribute data refers to identifiers or characteristics of an item. For example, item data can be extracted to determine attributes such as item labels, dietary restrictions, and item identifiers (IDs). Similarly, visual data can be extracted to determine visual attributes such as item color and item shape. The item attributes are extracted by multi-modal data sources which incorporate multiple modes or types of data that comprise text, image, visual data sources to provide a comprehensive view of the data.

The item attribute module 225 addresses attribute errors for items. The attribute error detection in multi-modal product data additionally incorporates user engagement and preferences to further address item attribution errors. The item attribute module 225 comprises attribute extraction and cross-checking. Attribute extraction extracts attributes of an item from several data sources. Cross-checking refers to confirming the attributes by checking the attributes from the multi-modal data sources and determining the attributes by comparing the attributes from the varying data sources. By incorporating multi-modal attribute extraction and cross-checking, the item attribute module 225 effectively determines attributes for item data of a multi-modal nature.

Specifically, the item attribute module 225 accesses a database of an online system 140 including one or more items. The received databases may be from varying third-party sources. For example, different retailers provide different databases of item data. Further, different retailer item databases are structured differently and may include attributes not included in other item databases. One retailer's third-party database, for example, may include attribute data describing vegan and non-vegan food items which are not described in other third-party databases.

For an item, the item attribute module 225 extracts attributes from two or more data sources during the attribute extraction step. The two or more data sources may have different item data modalities. In one or more embodiments, for an item, attribute extraction includes extracting attributes from a text-based data source by applying a text-based machine learning language model to e.g., text descriptions of the item. The text-based model is a type of machine learning model designed to process, analyze, and derive attributes of the item from text descriptions of the item. The item attribute module 225 accesses several text-based machine learning models to determine text-based item attributes. Different models such as Regex models, Name Entity Recognition (NER) models, and Large Language Models LLM based models are utilized to extract product attributes from text data.

In one instance, regular expression (“regex”) based extraction identify patterns and creates regex templates to identify attributes across an item database. For example, “(?:\hat{ }|) whole (?: |-|_)?grain(?=$∥,|\.)” could be a template to extract the whole-grain attribute. In one instance, a NER model is applied to text data of the item, and one or more entity classifications can be generated by the model. In one instance, a LLM based extraction extracts product attributes from unstructured text data by prompting the LLM to return structured attribute data based on the given product information. For example, the item attribute module 225 receives item data from an item database and the module prompts a LLM to identify item labels and identifiers. For example, an example prompt to the LLM is the following:
Based on the given product information, extract product attributes that can be used to create a product specification table to show in this product's online shopping webpage. Return in JSON dictionary format. The dictionary values should be the product attributes or features. The dictionary keys should be short product attribute names corresponding to the product attributes. Output an empty dictionary if no important product attributes are mentioned in the product information. Do not put attributes related to other variants for this product in the dictionary. Fill in either “true” or “false” as the dictionary values if the corresponding attribute name could be a boolean attribute.
Following is the expected json format. Only output json data

{
ATTRIBUTE_NAME: a list of attribute values corresponding to the
ATTRIBUTE_NAME
}

product name:
ABC Co. Milk Chocolate Almond Ice Cream Bars
category:
Food>Frozen Food>Frozen Desserts>Ice Creams>Ice Cream Bars
product description:
One 3 ct package of ABC Co. Milk Chocolate Almond Ice Cream Bars, ABC Co.
Vanilla Milk Chocolate Almond Ice Cream Bars are made with milk and cream not treated with rBST*, . . .
output:

```
{
  “Package Size”: [“3 ct”],
  “Flavor”: [“Vanilla Milk Chocolate Almond”],
  “Ingredients”: [“Milk”, “Cream”,
  “Roasted Almonds”, “Milk Chocolate”],
  “Gluten Free”: [true],
  “rBST Free”: [true],
  “OU Kosher dairy certified”: [true],
  “Brand”: [“ABC Co.”],
  “Product Type”: [“Ice Cream Bar”]
}
```

In one or more embodiments, for an item, attribute extraction includes extracting attributes from an image-based data source by applying an image-based ML model to an image of the item. An image-based model is a type of machine learning model that analyzes and interprets visual data, such as images, to extract meaningful attributes. The item attribute module 225 accesses several models such as multi-modal LLMs, image classification-based models, and Optical Character Recognition (OCR) models. Multi-modal LLMs are prompted to determine and extract visual elements of the received item data to determine visual attributes of the item. The image-classification models can be trained to identify distinguishing labels and attributes for catalog images of an item. For example, the classification model can determine whether the product image has an attribute or not (such as brand, keto, gluten-free). The image classifier can be trained using this training data and predict if an attribute is present or not across all the remaining catalog images. Further, the OCR models detect text from received images to identify product labels for an item. The extracted text can be in turn given to an LLM or other text classifiers such as NER based extraction to understand the text.

In further embodiments, the item attribute module 225 extracts one or more attributes obtained from a third-party database. For example, the item attribute module 225 receives attributes identified from additional third-party sources or online database sources. The third-party sources may include a third-party database source that identifies attributes of organic and non-organic food items that are not described by the received item database.

In one or more embodiments, the item attribute module 225 extracts one or more attributes from user engagement data for the item. For example, the item attribute module 225 may receive customer preference data to determine if the determined item attributes correspond to the customer preferences. In one or more embodiments, the item attribute module 225 identifies whether the attributes assigned to a product are true. For example, users can optionally put their preferences into a shopping profile, such as vegetarian, gluten-free, kosher, etc. As such, items can be flagged to update the corresponding attributes in the following two scenarios. First, a relatively lower conversion rate may be observed for a product with attribute X (e.g., gluten-free) from users having preference for attribute X (e.g., gluten-free). Then, it is likely the attribute X is not present for the product and there may be a potential error. Second, a relatively high conversion rate for a product without attribute X (e.g., gluten-free) may be observed from users having preference for attribute X (e.g., gluten-free). Then, it is likely the attribute X is present for the product.

After the attributes are extracted, the item attribute module 225 performs cross-checking of the extracted attributes for the item to determine whether the attributes from the two or more data sources contradict each other. The item attribute module 225 receives the set of attributes extracted from the multiple data sources and compares the attributes for the received item data. The item attribute module 225 determines the attributes by comparing the extracted attributes to identify potential contradicting attributes extracted from the several data sources. For example, the item attribute module 225 may flag an attribute for review if one data source determines the received item is vegan while another data source extracts ingredients of an egg for the received item.

In one or more embodiments, the item attribute module 225 receives a ranking of sources within each source type to resolve conflicting attributes. For example, within the text-based models source type, attributes extracted from an LLM are ranked higher than those from a RegEx model. Thus, the ranking system may place a higher confidence in attributes extracted from the LLM than that of the RegEx model. Similarly, within the image data source type, attributes from an OCR model may be ranked higher than those from other visual data extraction methods. This ranking system ensures consistent resolution of conflicting attributes across different source types item attribute module.

In one or more embodiments, the item attribute module 225 may prioritize resolving contradicting attributes between different source types if the ranks of the models or methods within the source types exceed predetermined thresholds. As an example, the item attribute module 225 may prioritize resolving conflicting attributes between text-based and image-based sources if the rank of the text-based model exceeds a predetermined threshold and the rank of the image-based source also exceeds a predetermined threshold. This ensures that the item attribute module 225 prioritizes resolving contradicting attributes for contradictions between high-confidence data sources.

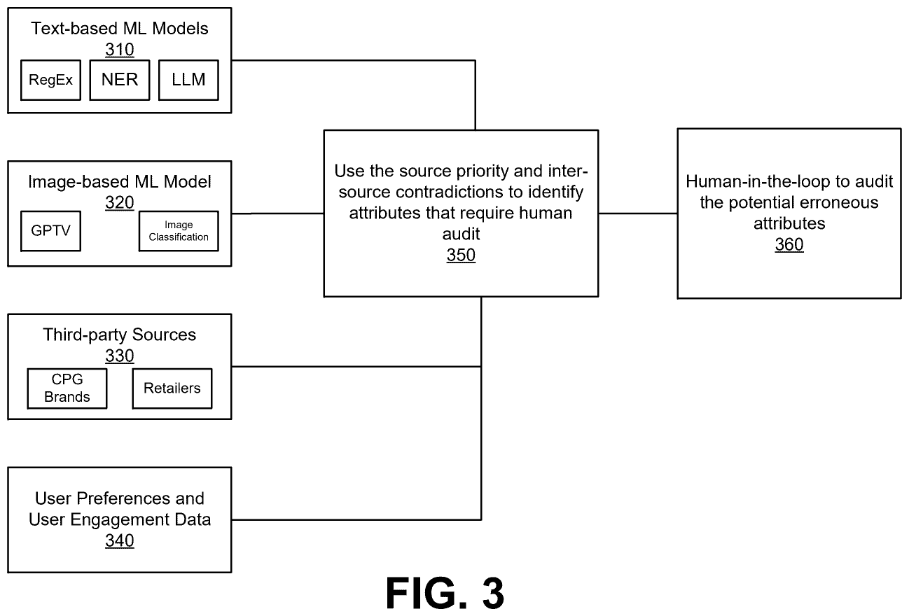

The item attribute module 225, responsive to determining a contradiction is within the set of extracted attributes, provides the contradicting attributes to be confirmed for error. The contradicting attributes may additionally be sent for manual verification. FIG. 3 further illustrates a process performed by the item attribute module 225.

FIG. 3 illustrates a process for extracting attributes and cross-checking the extracted attributes. The item attribute module 225 extracts attributes through multi-modal sources illustrated in FIG. 3. The multi-modal sources are, for example, text-based ML models 310, image-based ML model 320, third party sources 330, and customer preferences and engagement data 340. FIG. 3 illustrates examples of the several models for which each multi-modal data source extracts attributes of the received data. For example, the text-based ML model 310 illustrate the several types of models (Regex, NER, LLM) within a data source extraction approach. Further, the order of the several types of models for the NLP-based extraction may illustrate an example of a priority ranking of the models wherein the item attribute module 225 may assign a higher confidence to the attributes derived from one model over that of another model.

The item attribute module 225 determines inter-source contradictions 350 between multi-modal attributes extracted from the multi-modal extraction approaches. The item attribute module 225 receives the multi-modal based approaches when determining and identifying potential inter-source contradictions that require human audit 350. When determining and identifying potential inter-source contradictions 350, the item attribute module 225 may extract contradicting attributes within an extraction approach. For example, the item attribute module 225 receives contradicting attributes from the image-based ML model 320 wherein the ranking of the sources is GPT-V and then the image classification models. If the item attribute module 225 receives contradicting attributes from the GPT-V model and the image classification model, then the item attribute module 225 places a higher confidence on the attributes from the GPT-V model when evaluating the validity of an extracted attribute.

Further, in response to determining at least a contradicting set of attributes based on the multi-modal data sources, the item attribute module 225 sends the possible contradicting attributes to the human-in-the-loop to audit the potential erroneous attributes 360.

The item attribute module 225 addresses the problem of attribute error detection in multi-modal product data. By applying attribute extraction and cross-checking, the item attribute module 225 effectively determines and flags contradicting attributes for review. The item attribute module 225 addresses inconsistencies within data sources and limitations of extraction algorithms. In conventional item attribute determination, there is a lack of effective validation mechanisms, and current methods primarily rely on manual verification, which is time-consuming, labor-intensive, and prone to human errors. Moreover, other methods lack the capability to effectively cross-check attributes across different sources and modalities. This results in a high rate of false positives and negatives, thereby reducing the reliability of the error detection process. The process described herein collectively contributes to a more accurate and reliable error detection process, thereby significantly improving the quality of product data.

In one or more embodiments, the item attribute module 225 in conjunction with the machine learning training module 230 may perform fine-tuning of the one or more machine-learning models that are used to extract attribute values. For example, an LLM as a text-based transformer model or an image classification model as an image-based ML may be further fine-tuned. To perform fine-tuning, the item attribute module 225 obtains training data from previous instances of contradictions within a set of extracted attributes from the models, where the contradicting attributes to be confirmed for error.

In one or more embodiments, the item attribute module 225 identifies positive instances of feedback in which positive feedback was received during the verification process by the human reviewer. In other words, a positive instance of feedback occurs where the human reviewer confirms the correct attribute for the item is the extracted attribute from the machine-learning model. In other embodiments, the item attribute module 225 may identify negative instances of feedback during the verification process by the human reviewer for a set of contradicting extracted attributes. In other words, a negative instance of feedback occurs where the human reviewer confirms that the correct attribute for the item is not the extracted attribute from the machine-learning model.

The item attribute module 225 obtains data related to the item as pairs of prompts and positive outputs for the training dataset. The item attribute module 225 encodes the data into a set of input tokens, in which a token is a numerical vector representing a word, sub-word, phrase, pixels, latent pixels, in a latent space. When the transformer architecture of the machine-learned model (e.g., LLM) is of an autoregressive architecture, the LLM may be applied to generate one or more output tokens that correspond to the positive outputs (i.e., verified correct attribute values for an item). An output token is decoded to determine a probability that the decoded token corresponds to a corresponding token in the positive output.

The item attribute module 225 determines a loss function across the one or more output tokens that indicates a difference (e.g., logit difference) between the tokens in the positive outputs and the output tokens generated by the forward pass of the transformer model. As an example, the loss function may be an NLP loss for each token combined across one or more output tokens generated for the positive text. The item attribute module 225 obtains one or more terms from the loss function and performs backpropagation to update parameters of the transformer architecture.

Returning to FIG. 2, the machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

### 2. Multi-Modal Attribute Extraction Platform

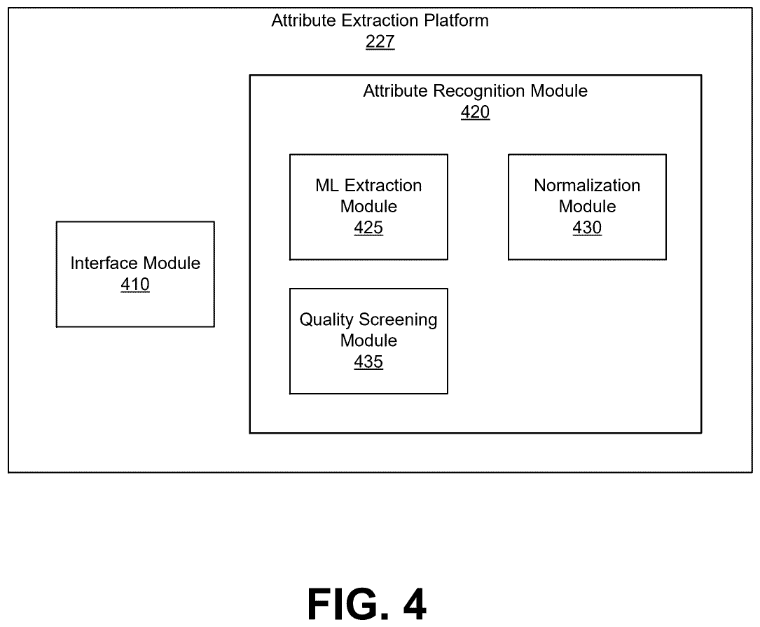

The attribute extraction platform 227 incorporates a multi-modal machine learning model designed to extract attributes from a plurality of data sources through a unified extraction framework. The attribute extraction platform 227 allows for customizability by accessing a customizable set of inputs that includes a desired attribute type, data of the item from multiple data sources, contextual information associated with the items, and a dynamically generated prompt tailored for attribute extraction. The attribute extraction platform 227 reliably determines attributes of the items by receiving a set of attributes from the multi-modal machine learning model and performs a normalization and quality check process. Further details of the attribute extraction platform 227 are illustrated in FIG. 4-6.

FIG. 4 illustrates an example system architecture for an attribute extraction platform 227, in accordance with one or more embodiments. The attribute extraction platform 227 includes an interface module 410 and an attribute recognition module 420. The attribute recognition module 420 utilizes a multi-modal machine learning model configured to extract attributes of items from multiple data source types through the integrated and unified attribute extraction platform 227.

The interface module 410 renders an interface on a client device to receive a set of inputs from the customer via the user interface. The interface module 410 receives a set of inputs to the attribute recognition module 420 to extract attributes of an item. The interface that is rendered on the client device allows for users to define desired attributes for extraction by specifying a set of inputs including the attribute name of a desired attribute, type (e.g., string, dictionary, number, Boolean), and description. Additionally, the interface may receive as a set of inputs an appropriate LLM extraction model type, its parameters, and a prompt template to guide the extraction process. Additionally, the interface may receive as a set of inputs an attribute normalization function. The interface is also configured to receive a set of data associated with the item from which to extract the desired attribute. The data associated with the item may be from one or more data source types. In one or more embodiments, the interface module 410 may additionally receive example prompts for the LLM to provide a more comprehensive understanding to the prompt template.

In one or more embodiments, the attribute recognition module 420 receives the set of inputs received from the interface including the desired attribute, attribute type, attribute description, an appropriate LLM extraction model type, its parameters, and a prompt template to guide the extraction process and extract attribute values for the desired attributes from multi-modal data sources. The attribute recognition module 420 is also configured to receive a set of data associated with the item. The data associated with the item may be from one or more data source types. Additionally, the attribute recognition module 420 may be configured to receive as a set of inputs an attribute normalization function.

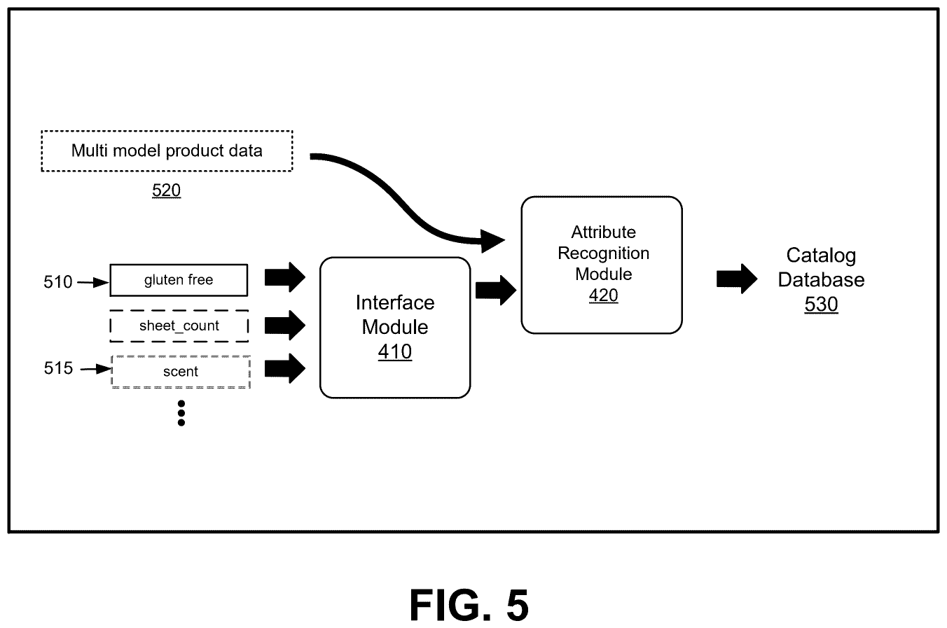

FIG. 5 illustrates an example attribute recognition process, in accordance with one or more embodiments. The interface module 410 renders an interface on a client device to receive a set of inputs from the user (e.g., developer) via the user interface. As an example, in FIG. 5, the interface module 410 receives a set of inputs including desired attributes for whether an item is gluten free 510 and the scent 515 of items. The attribute recognition module 420 obtains multi-modal product data 520 for a set of items specified in the inputs. As an example, the multi-modal product data may include images of a set of items and text-based data of the set of items. The attribute recognition module 420 obtains the remaining inputs from the interface module 410 including, but not limited to, for each desired attribute, the attribute type, attribute description, the appropriate LLM extraction model type, its parameters, and the prompt template to guide the extraction process. The attribute recognition module 420, for each item of the set of items, extracts one or more attribute values for the desired attributes. In one embodiment, the attribute recognition module 420 may receive as input an attribute normalization function. The attribute recognition module 420 stores the extracted attribute values for the desired attributes for gluten free 510 items and the scent 515 of items 520 to a catalog database 530 of the attribute extraction platform 227.

Returning to FIG. 4, the attribute recognition module 420 includes an ML extraction module 425, a normalization module 430, and a quality screening module 435. In one or more embodiments, the attribute extraction platform 227 performs a “development phase” to determine an optimal configuration of a set of inputs for one or more desired attributes by allowing a user to iteratively refine the configuration of the set of inputs to determine an optimal configuration for extracting attributes of a set of items. During the development phase, the attribute extraction platform 227 extracts values for the desired attributes of items to iteratively determine the optimal configuration of the set of inputs. During the development phase, the attribute extraction platform 227 allows the user to determine the configuration of the set of inputs to ensure the accurate and efficient extraction of the desired attributes.

As described in further detail below, in one or more embodiments, the attribute extraction platform 227 also performs a production phase to recognize and determine attributes based on the determined optimal configuration of the set of inputs for a larger batch of items. During the production phase, the attribute extraction platform 227 determines attributes in a structured format for a batch of items.

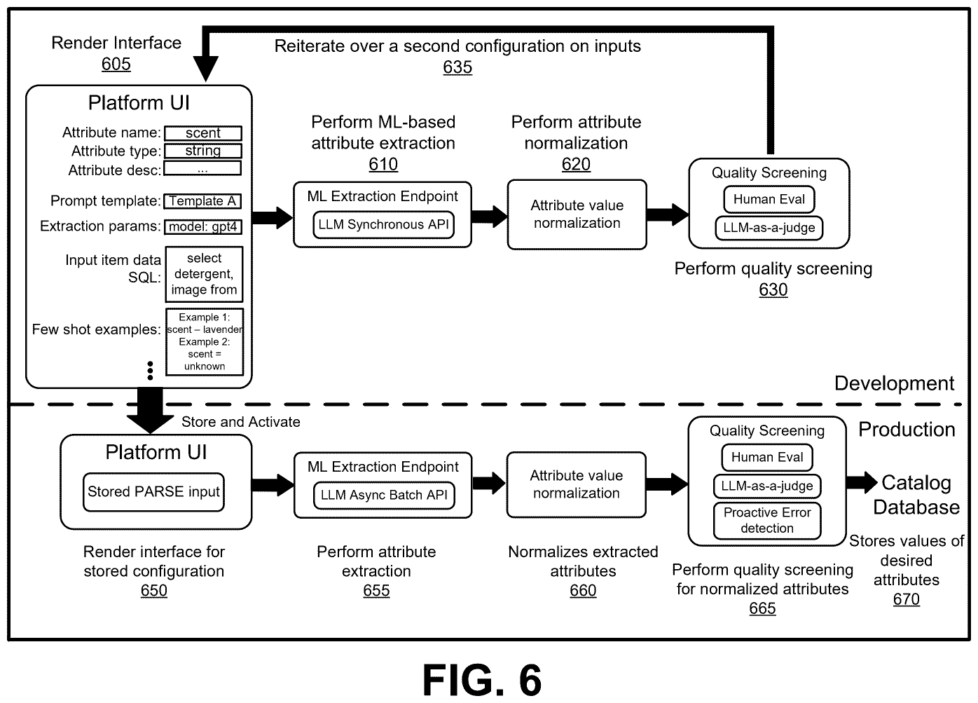

FIG. 6 illustrates a detailed workflow of the attribute extraction platform 227, in accordance with one or more embodiments. As described in conjunction with FIG. 4, the interface module 410 renders 605 an interface on a client device to receive a set of inputs from the user interface. As shown in FIG. 6, the example interface includes instructions to receive a set of user inputs specifying scent as the attribute name, “string” as the attribute type, “a scent is a smell associated with the item” as the attribute description, “Template A” as the prompt template, “gpt4” for the LLM extraction model type, and its required parameters.

Additionally, the example interface includes instructions to receive a set of inputs specifying the instructions for obtaining the data related to one or more items, as an example “select laundry detergent, any brand, image from database table DB1.” The instructions may be configured as SQL code that can be executed on a database to extract the item data specified in the code. The inputs may also include a few examples of extracting the data for the desired attributes, for example, “Example 1: scent-lavender; Example 2: scent=unknown” for two example items.

The ML extraction module 425 performs 610 ML-based attribute extraction based on the set of inputs received from the interface. Specifically, the ML extraction module 425 constructs a prompt to one or more LLMs including a set of inputs received from the interface, such as an attribute name, type, description, an appropriate LLM extraction model type, its required parameters, an attribute normalization function, and item data associated with the items from a plurality of data source types. In one or more embodiments, the ML extraction module 425 generates a prompt to the multi-modal model with the desired extraction model type by populating the received prompt template with the received set of inputs. As an example, the generated prompt for a received set of inputs is:
prompt_: |-
   Your task is to extract the “sheet count” attribute for a given product from various data sources.
   sheet count attribute definition:
   The total number of sheets or wipes of the product. The type of the extracted value should be a string that consists of an integer with “ct” as the unit, e.g. XXX ct.
      If the product is a multi-pack, the sheet count should equal the number of packs times the number of sheets/wipes per pack.
      In cases where the sheet/wipe count value cannot be inferred from the available data sources, assign ‘unknown’ as the value.
   Let's think step-by-step.
   The given product image and the product data sources below are where you need to extract the {attribute_name} attribute.
   --------
   item name: {item_name}
   item description: {item_description from item data}

The ML extraction module 425 provides the prompt to one or more LLMs as specified from the extraction type in the set of inputs. Using the selected LLM extraction process, the attribute extraction module 425 extracts the attribute value for the item and calculates a confidence score to assess the reliability of the extracted value.

In one or more embodiments, the ML extraction module 425 supports multiple extraction types for attribute extraction using large language models (LLMs) to address varying requirements and to balance performance with cost efficiency. In one or more instances, a first approach utilizes high-performance LLMs that offer strong extraction capabilities but may incur higher operational costs. In one or more instances, a second approach utilizes an internally managed system, which offers extraction capabilities for a small amount of computational resources without incurring higher operational costs. In one or more instances, a third approach is a cascading strategy, where a sequence of models is queried in order of complexity and operational cost. If a model produces a satisfactory result, the process terminates early, avoiding unnecessary queries to more resource-intensive models. In one or more embodiments, the user may specify the type of extraction type for attribute extraction via the interface.

In one or more embodiments, the ML extraction module 425 computes a confidence score for the extracted attribute values by using a self-verification technique. The ML extraction module 425 determines the confidence score of the extracted attributes by querying an LLM with a prompt, wherein the prompt includes instructions to evaluate whether the extracted attribute value is consistent with the received data associated with the item and the attribute's definition. The prompt may include specific instructions to instruct the LLM to output either “yes” or “no,” enabling the system to compute the probability of “yes” as the confidence score. In one embodiment, attribute values with low confidence scores may be flagged for human review to determine the extracted attribute values of the item.

The normalization module 430 performs 620 attribute value normalization to a set of extracted attributes of the item. Given that the attribute recognition module 420 extracts attributes for varying attribute types, the normalization module 430 supports multiple normalization functions according to its attribute type, which may be further selected by the user. The normalization module 430 normalizes and standardizes the extracted attributes according to the attribute normalization function specified in the set of inputs.

As an example, a normalization function may be a text-based attribute value filter. The text-based attribute value filter allows users to identify and filter undesired attribute values for regex values. Attribute values matching any specified regex can be replaced with NULL to prevent ingestion of invalid or irrelevant data. For instance, when an LLM outputs “unknown” for an attribute it cannot extract, this normalization function can prevent such placeholder values from being included in the catalog, thereby maintaining data quality.

As another example, a normalization function may be a dictionary-based attribute value filter. The dictionary-based attribute value filter standardizes extracted attribute values into a consistent format. As an example, the attribute for flavor, berry flavor could be extracted as “berries” or “Berry” from items, the dictionary-based attribute value filter normalizes these two variations into the same canonical form. In one or more embodiments, users may provide a dictionary containing attribute value variants as keys and their corresponding canonical forms as values. Using this dictionary, the dictionary-based attribute value filter is applied to determine an exact match lookup to replace extracted attribute values with its canonical form. In one or more embodiments, to handle new attribute value variants not in the received dictionary, the dictionary-based attribute value filter is applied to determine its most similar dictionary key using an embedding similarity score.

The quality screening module 435 performs 630 quality screening by utilizing automated evaluation methods and human-in-the-loop evaluation methods to confirm and verify the attribute values. During the development phase, the quality screening module 435 includes as input a set of attribute values wherein a human-in-the-loop may confirm the determined attribute values. Additionally, the unified extraction platform 227 may incorporate automated evaluation using LLMs to accelerate the assessment process and enable rapid iteration.

During the development phase, users may input a smaller set of items. The attribute recognition module 420 receives as input a configuration of the set of inputs and data associated with the set of items. The attribute recognition module 420 extracts the desired attributes for the set of inputs. The quality screening module 430 performs quality screening to assess the quality and reliability of the extracted attributes.

In one or more embodiments, the attribute recognition module 420 renders and generates a human evaluation interface that enables human auditors to evaluate the extracted values. This interface allows auditors to label the “gold standard” values, serving as a benchmark for comparison. This allows for the attribute recognition module 420 to compute quality metrics to quantify the accuracy and effectiveness of the extraction process.

In one or more additional embodiments, the attribute recognition module 420 will incorporate an LLM-based auto-evaluation mechanism, leveraging LLMs as judges to automate the evaluation process. This automated evaluation will enable faster feedback by comparing extracted values against predefined benchmarks or expected outputs.

The attribute extraction platform 227 allows the user to reiterate 635 the workflow described in FIG. 6, over a second configuration of a set of inputs and so on to determine an optimal configuration of the set of inputs that leads to the optimal accuracy and effectiveness of the desired attributes. In one or more embodiments, the attribute extraction platform 227 stores the optimal configuration selected by the user in association with the one or more desired attributes, so that the stored configuration can be used for attribute recognition during the production phase.

During the production phase, the attribute extraction platform 227 may receive as input a set of desired attributes for a batch of items. The interface module 410 renders 650 an interface with the stored configuration of the set of inputs for the desired attributes for the batch of items similarly to that as described with respect to step 605.

The ML extraction module 425 performs 655 attribute extraction. During the production phase, based on the stored optimal configuration, the ML extraction module 425 generates a prompt to extract attributes from a batch of items. In one or more embodiments, during the production phase, the ML extraction module 425 may apply batch processing to the LLM to extract the values for the desired attributes for the batch of items that may include a significant number of items. This is because batch processing may be less computationally costly for determining attributes over a batch of items over the individual processing of attributes for each item in the batch of items.

The normalization module 430 normalizes 660 the extracted values for the desired attributes for the batch of items. Substantially similar or identical to that disclosed during the development phase, the normalization module 430 supports multiple normalization functions according to its attribute type, which may be determined by the attribute normalization function specified in the determined optimal set of input configurations. The normalization module 430 normalizes and standardizes the extracted attributes according to the attribute normalization function specified in the set of inputs.

During the production phase, the quality screening module 435 performs 665 quality screening for the normalized attributes for the batch of items. The quality screening module 435 performs quality screening by utilizing automated evaluation methods and human-in-the-loop evaluation methods to confirm the attribute data, but also during the production phase, the quality screening module 435 may also perform proactive error detection. During the production phase, the quality screening module 435 continuously performs periodic quality screenings to proactively detect any errors for the determined attributes for the batch of items. During the production phase, the quality screening module 435 performs periodic sampling of extraction results evaluated by a human-in-the-loop or LLMs to detect quality changes of the determined attributes. Further, during the production phase attributes with a determined low confidence value are flagged for review to enable proactive error detection and correction by the human-in-the-loop.

The attribute extraction platform 227 stores 670 the values for the desired attributes for the batch of items in a catalog database associated with the attribute extraction platform 227. Based on the extracted attribute values, the online system 140 may cause display of one or more items for display to a customer user. For example, the online system 140 may display one or more values for an attribute (e.g., scent). Responsive to receiving a selection from the user (e.g., “lavender”), the online system 140 may provide a filtered set of items that are associated with the selected attribute value (e.g., filtered set of detergents with lavender scent).

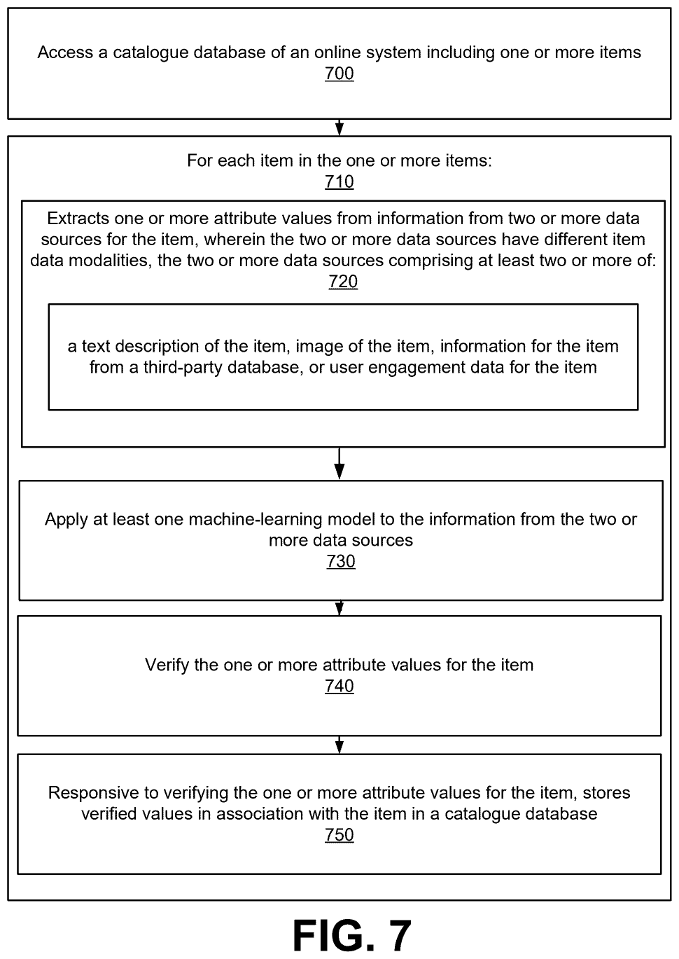

FIG. 7 is a flowchart for an item attribute module, in accordance with some embodiments. Alternative embodiments may include more, fewer, or different steps from those illustrated in FIG. 7 and the steps may be performed in a different order from that illustrated in FIG. 7. These steps may be performed by an online system (e.g., online system 140). Additionally, each of these steps may be performed automatically by the online system 140 without human intervention.

The item attribute module accesses 700 a catalogue database of an online system including one or more items. For each item in the one or more items 710, the item attribute module extracts 720 one or more attribute values from information from two or more data sources for the item, wherein the two or more data sources have different item data modalities, the two or more data sources comprising at least two or more of: a text description of the item, image of the item, information for the item from a third-party database, or user engagement data for the item. For each item in the one or more items 710, the item attribute module applies 730 at least one machine-learning model to the information from the two or more data sources. For each item in the one or more items 710, the item attribute module verifies 740 the one or more attribute values for the item. For each item in the one or more items 710, responsive to verifying the one or more attribute values for the item, the item attribute module stores 750 verified values in association with the item in a catalogue database.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that are issued on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
accessing a catalogue database of an online system including one or more items;
for each item in the one or more items:
extracting one or more attribute values from information from two or more data sources for the item, wherein the two or more data sources have different item data modalities, the two or more data sources comprising at least two or more of:
a text description of the item,
image of the item,
information for the item from a third-party database, or
user engagement data for the item,
wherein extracting the one or more attribute values further comprises applying at least one machine-learning model to the information from the two or more data sources;
verifying the one or more attribute values for the item; and
responsive to verifying the one or more attribute values for the item, updating the catalogue database to store verified values in association with the item in the catalogue database.

2. The method of claim 1, further comprising:
cross-checking the extracted attribute values for the item to identify whether two or more attribute values extracted from the two or more data sources contradict each other; and
responsive to identifying that there is a contradiction within the two or more attribute values, providing the two or more contradicting values to an audit system for verification.

3. The method of claim 2, wherein extracting the one or more attribute values further comprises extracting the two or more attribute values, comprising:
applying a text-based machine-learning model to the text description of the item; or
applying an image-based machine-learning model to the image of the item.

4. The method of claim 2, further comprising:
ranking the two or more data sources for the item, and
wherein cross-checking the extracted attribute values for the item further comprises identifying that there is the contradiction between the extracted attribute values responsive to identifying the two or more data sources are above a threshold ranking.

5. The method of claim 1, further comprising:
transmitting instructions to cause display of an interface on a client device; and
receiving, via the interface, a set of inputs from the client device, wherein the set of inputs includes at least one desired attribute for extraction and instructions for obtaining the information from the two or more data sources for each item in the one or more items.

6. The method of claim 5, further comprising:
generating a prompt from the set of inputs received from the interface, the prompt requesting extraction of attribute values for the desired attribute for the one or more items;
providing the prompt for execution to a multi-modal machine-learning model; and
extracting the one or more attribute values for each item from a response from the multi-modal machine-learning model.

7. The method of claim 6, wherein the set of inputs further includes a type of model for execution, and wherein the multi-modal machine-learning model is the type of model specified in the set of inputs.

8. The method of claim 5, further comprising:
iteratively performing an attribute extraction process for the at least one desired attribute using different sets of inputs;
receiving, from a user, a selection of a desired set of inputs based on one or more evaluation results of the attribute extraction process; and
storing the desired set of inputs.

9. The method of claim 1, further comprising:
transmitting instructions to a second client device to cause display of a set of attribute values;
receiving a selection of an attribute value from a user of the second client device; and
presenting a filtered set of items associated with the selected attribute value.

10. A non-transitory computer-readable storage medium storing computer instructions, the computer instructions, when executed by one or more processors, cause the one or more processors to perform operations further comprising:
accessing a catalogue database of an online system including one or more items;
for each item in the one or more items:
extracting one or more attribute values from information from two or more data sources for the item, wherein the two or more data sources have different item data modalities, the two or more data sources comprising at least two or more of:
a text description of the item,
image of the item,
information for the item from a third-party database, or
user engagement data for the item,
wherein extracting the one or more attribute values further comprises applying at least one machine-learning model to the information from the two or more data sources;
verifying the one or more attribute values for the item; and
responsive to verifying the one or more attribute values for the item, updating the catalogue database to store verified values in association with the item in the catalogue database.

11. The non-transitory computer-readable storage medium of claim 10, wherein the computer instructions, when executed by the one or more processors cause the one or more processors to perform operations further comprising:
cross-checking the extracted attribute values for the item to identify whether two or more attribute values extracted from the two or more data sources contradict each other; and
responsive to identifying that there is a contradiction within the two or more attribute values, providing the two or more contradicting values to an audit system for verification.

12. The non-transitory computer-readable storage medium of claim 11, wherein the computer instructions to extract the one or more attribute values, when executed by the one or more processors cause the one or more processors to perform operations further comprising:
applying a text-based machine-learning model to the text description of the item; or
applying an image-based machine-learning model to the image of the item.

13. The non-transitory computer-readable storage medium of claim 11, wherein the computer instructions, when executed by the one or more processors cause the one or more processors to perform operations further comprising:
ranking the two or more data sources for the item, and
wherein cross-checking the extracted attribute values for the item further comprises identifying that there is the contradiction between the extracted attribute values responsive to identifying the two or more data sources are above a threshold ranking.

14. The non-transitory computer-readable storage medium of claim 10, wherein the computer instructions, when executed by the one or more processors cause the one or more processors to perform operations further comprising:
transmitting instructions to cause display of an interface on a client device; and
receiving, via the interface, a set of inputs from the client device, wherein the set of inputs includes at least one desired attribute for extraction and instructions for obtaining the information from the two or more data sources for each item in the one or more items.

15. A computer system comprising:
a processor; and
a non-transitory computer readable storage medium storing instructions that, when executed by the processor, cause the processor to perform actions comprising:
accessing a catalogue database of an online system including one or more items;
for each item in the one or more items:
extracting one or more attribute values from information from two or more data sources for the item, wherein the two or more data sources have different item data modalities, the two or more data sources comprising at least two or more of:
a text description of the item,
image of the item,
information for the item from a third-party database, or
user engagement data for the item,
wherein extracting the one or more attribute values further comprises applying at least one machine-learning model to the information from the two or more data sources;
verifying the one or more attribute values for the item; and
responsive to verifying the one or more attribute values for the item, updating the catalogue database to store verified values in association with the item in the catalogue database.

16. The computer system of claim 15, further comprising:
cross-checking the extracted attribute values for the item to identify whether two or more attribute values extracted from the two or more data sources contradict each other; and
responsive to identifying that there is a contradiction within the two or more attribute values, providing the two or more contradicting values to an audit system for verification.

17. The computer system of claim 16, wherein extracting the one or more attribute values further comprises extracting the two or more attribute values, comprising:
applying a text-based machine-learning model to the text description of the item; or
applying an image-based machine-learning model to the image of the item.

18. The computer system of claim 16, further comprising:
ranking the two or more data sources for the item, and
wherein cross-checking the extracted attribute values for the item further comprises identifying that there is the contradiction between the extracted attribute values responsive to identifying the two or more data sources are above a threshold ranking.

19. The computer system of claim 15, further comprising:
transmitting instructions to cause display of an interface on a client device; and
receiving, via the interface, a set of inputs from the client device, wherein the set of inputs includes at least one desired attribute for extraction and instructions for obtaining the information from the two or more data sources for each item in the one or more items.

20. The computer system of claim 15, further comprising:
transmitting instructions to a second client device to cause display of a set of attribute values;
receiving a selection of an attribute value from a user of the second client device; and
presenting a filtered set of items associated with the selected attribute value.
